(19) United States
(12) Patent Application Publication
(10) Pub. No.: US 2004/0247956 A1
(43) Pub. Date: Dec. 9, 2004

(54) Method for operating a fuel cell with variable operating pressure

(75) Inventors: Christian Duelk, Burggrumbach (DE); Sven Schnetzler, Marburg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/859,804

(22) Filed: Jun. 3, 2004

(30) Foreign Application Priority Data
Jun. 5, 2003 (DE) DE 103 25 449.8

(51) Int. Cl. H01M 8/04

(52) U.S. Cl. 429/13; 429/23; 429/25

(57) ABSTRACT

A method for operating a fuel cell system with variable pressure, whereby the fuel cell system has a fuel cell unit (1) with a plurality of fuel cells, and a cathode (2) of a fuel cell is supplied with an oxidant that chemically reacts with a fuel which is supplied to an anode (3) of the fuel cell. Electrical output power is provided by the fuel cell system from the reaction in the fuel cell unit (1) so as to supply electrical consumers (4). The electrical output at a load level of the fuel cell unit (1) is varied as a function of the pressure, and the pressure is applied from at least one of the oxidant supply units (5) conveying the oxidant. The pressure dependence of the electrical output of the fuel cell unit (1) to an electrical output or power required for operating the oxidant supply unit (5) is adjusted at the load level at which electrical power is demanded by the fuel cell system, and a pressure is set for the oxidant that is generated by a minimum required electrical output or power of the oxidant supply unit (5).

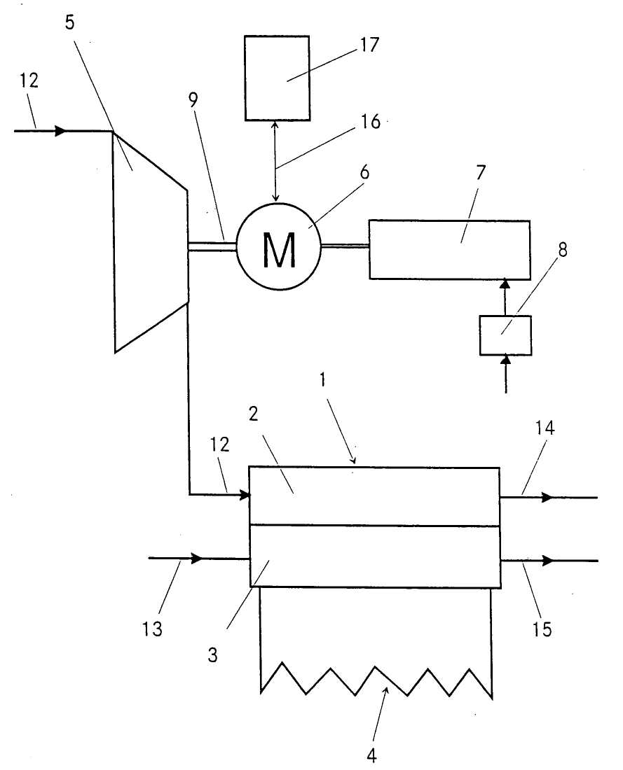

This claims the benefit of German Patent Application No. 103 25 449.8, filed Jun. 5, 2004 and hereby incorporated by reference herein.

The present invention relates to a method for operating a fuel cell system with variable operating pressure.

### BACKGROUND

It is known how to operate fuel cell systems with variable pressure. For example, German Patent Application DE 100 18 081 A1 describes a method for controlling the air supply as a function of excess air, taking into account the output of the fuel cell. In particular, control as a function of excess air especially occurs within a partial load range of the fuel cell. In addition to control as function of excess air, control can also be exercised as a function of pressure in order to adjust the air supply provided to the fuel cell. A performance-enhancing reduction of the mass flow of air supplied to the fuel cell is set, taking into account the output of the fuel cell at the moment.

### BRIEF SUMMARY OF THE INVENTION

The present invention provides a method for operating a fuel cell system with variable pressure, whereby the fuel cell system has a fuel cell unit (1) that has a plurality of fuel cells, and a cathode (2) of a fuel cell is supplied with an oxidant that chemically reacts with a fuel which is supplied to an anode (3) of the fuel cell, whereby electrical output power is provided by the fuel cell system from the reaction in the fuel cell unit (1) so as to supply electrical consumers (4), and whereby the electrical output at a load level of the fuel cell unit (1) is varied as a function of the pressure, and the pressure is applied from at least one of the oxidant supply units (5) conveying the oxidant. The present invention is characterized in that the pressure dependence of the electrical output of the fuel cell unit (1) to an electrical output or energy required for operating the oxidant supply unit (5) is adapted or adjusted for the load level at which electrical power is demanded by the fuel cell system, and a pressure for the oxidant is set that is generated by a minimum required electrical output or power of the oxidant supply unit (5).

The pressure dependence of the fuel cell output to a power generated to drive an oxidant supply unit, preferably a compressor, that supplies the fuel cell unit with high-pressure oxidant, preferably air. A pressure is thereby set that only requires the minimum necessary electrical drive power from the oxidant supply unit for a given load level. This can minimize the parasitic electrical output or power required to drive the oxidant supply unit, and can increase the efficiency of the fuel cell system. It is furthermore possible to combine the advantages of high-pressure fuel cell systems and low-pressure fuel cell systems.

In a preferred development of the present invention, the adjustment may be made at each load level so that the efficiency can be optimized over the entire load range. It is particularly preferable for the pressure to change more or less continuously over the load range of the fuel cell system.

In one advantageous development, additional electrical components of the fuel cell system may be included in the adjustment to determine the minimum necessary electrical output of the oxidant supply unit at the load level. This can further improve efficiency. In addition, the adjustment can be factored into the design of the compressor to be used as the oxidant supply unit, preferably combined with an expander, to optimally adapt the efficiency characteristic of a compressor/expander head, or corresponding conventional impellers, to the pressure dependency of the fuel cell unit.

In another advantageous development, when the pressure is high, the operating temperature of fuel cell unit may be allowed to be higher than the temperature prevailing within a partial load range. This makes it easier to cool the fuel cell unit when it operates under a high load, especially a full load. The operating temperature of the fuel cell system can be adjusted as a function of demand or of load, which helps keep the fuel cell system from overheating.

In another advantageous development, the oxidant supply unit may be at least temporarily driven by a gas turbine in the fuel cell system. This lessens the load on the electric motor driving the oxidant supply unit.

In another advantageous development, the gas turbine may be heated by a combustion chamber in the fuel cell system. For example, this allows exhaust from the fuel cell system and/or fuel to be used for combustion. No additional components are required, and no additional space or weight is necessary.

In a useful development, the gas turbine may briefly drive the oxidant supply unit when the fuel cell system is subject to high loads. While the rated electrical compressor driving power at a full load remains the same, this feature enables the net electrical output from the fuel cell system to be far above the maximum possible load level of a system that only has an electrically driven air supply. In addition, cooling can be less problematic since the additionally-available driving power of the oxidant supply unit can substantially increase the system pressure at a full load, which enables the average operating temperature of fuel cell unit to be temporarily raised. Additionally, if the amount of heat to be removed is not restrictive, the fuel cell unit can be operated at higher system pressures even when the current density and hence the electrical output is high. This enables the current density of the fuel cell unit to be increased as well as the output power of the fuel cell unit, without changing the size of the fuel cell unit.

In another advantageous development, output from an electrical drive motor of the oxidant supply unit can supply consumers such as a propulsive drive when the oxidant supply unit is driven by the gas turbine. This relieves the load on the fuel cell unit.

### BRIEF DESCRIPTION OF THE DRAWING

The present invention will be further explained with reference to a drawing. The individual FIGURE shows a schematic representation of a preferred embodiment of a fuel cell using the method of the present invention.

### DETAILED DESCRIPTION

A preferred fuel cell system for implementing the method according to the invention comprises a fuel cell unit 1 with a plurality of fuel cells that preferably are stacked, whereby one or more fuel cell stacks can be electrically series-connected and/or parallel-connected in a familiar manner known to offer a desired voltage and current level to electrical consumers 4. A simplified fuel cell unit 1 is shown with a cathode 2 and an anode 3. Cathode 2 is supplied with an oxidant via a cathode-side feed line 12, whereas anode 3 is supplied with fuel via an anode-side feed line 13. The fuel and oxidant react in the fuel cells of fuel cell unit 1, and the reaction products are removed via cathode-side and anode-side discharge lines 14, 15. The reaction produces electrical voltage in fuel cell unit 1 that can be made available to electrical consumers 4, for example an electrical propulsive drive.

Other well-known details of a fuel cell system such as any supply tanks for the operating media, any gas generation system for generating hydrogen or a hydrogen-rich reformate as a fuel, exhaust treatment, any cooling, etc., can be provided. Air is preferably used as the oxidant and hydrogen as the fuel. Of course, other suitable operating media are conceivable such as pure oxygen as the oxidant, or methanol as the fuel, for example in so-called direct methanol fuel cells, or dimethyl ether and other conventional operating media that are well-known for operating fuel cells.

In cathode-side feed line 12, there is an oxidant supply unit 5, specifically a compressor, that is driven via a shaft 9 by an electric motor 6. Electric motor 6 is connected via signal lines 16 to a controller 17 that transmits demands for loads to electric motor 6 and receives performance data from electric motor 6. In addition, controller 17 can also contain additional operating data and parameters of the fuel cell system, and can especially process a performance demand for the fuel cell system such as the position of an accelerator pedal.

It is particularly preferable for fuel cell unit 1 to consist of so-called PEM fuel cells in which a proton-conducting membrane made of a polymer material is arranged between anode 3 and cathode 2. Other types of fuel cells are optionally conceivable. The cited PEM fuel cells are, however, suitable for a preferred propulsive drive or a power supply in vehicles (which are electrical consumers as defined herein), due to their low operating temperature.

In the method according to the present invention, the fuel cell system is operated with variable pressure. The fuel cell system offers electrical output power from the reaction in fuel cell unit 1 to supply electrical consumers 4. Both the cathode-side pressure of the oxidant and the anode-side pressure of the fuel can be similarly increased, or only the cathode-side pressure can be increased. It has been shown that increasing the partial pressure of the oxygen can increase the output of fuel cell unit 1. However, especially with PEM fuel cells, it is advantageous to have only a slight difference in pressure between cathode 2 and anode 3 to obviate additional measures for stabilizing the proton-conducting membrane in the fuel cells.

At one load level, consumers 4, especially the driving motor, demand electrical power from the fuel cell system, for example when a demand for power is transmitted to controller 17. A demand from the driving motor usually requires the fuel cell system to be highly dynamic. At the load level of fuel cell unit 1, the output power of fuel cell unit 1 can be varied as a function of pressure, whereby the pressure is generated at least by oxidant supply unit 5 conveying the oxidant. According to the present invention, the pressure dependence of the electrical output of fuel cell unit 1 with respect to an electrical power required for operating oxidant supply unit 5 is adjusted for that load level. These data can be specified as characteristic quantities of fuel cell unit 1 and oxidant supply agent 5 before commencing operation of the fuel cell system and, for example, can be archived in program maps and/or tables in controller 17.

Subsequently, a pressure for the oxidant is set that can be generated by the minimum required electrical output of oxidant supply unit 5. As a result, the pressure of the oxidant is only selected to be as high as necessary.

The adjustment of the pressure dependence of the electrical output of fuel cell unit 1 to the electrical output required for operating oxidant supply unit 5 preferably occurs at each load level. The pressure can be changed more or less continuously over the load range of fuel cell unit 1. The system efficiency can thereby be increased over the entire load range by minimizing the parasitic output of oxidant supply unit 5. This is particularly important for operating at a partial load, which is relevant to the power consumption of the fuel cell system under standard conditions.

Any other electrical components such as pumps, especially coolant pumps, fans, etc., of fuel cell system 1 may be included in the adjustment to establish the minimum necessary electrical output of oxidant supply unit 5 at the load level.

It is advantageous if, at a high pressure, the operating temperature of fuel cell unit 1 can be higher than the operating temperature under a partial load. A quantity Q/dT relevant for cooling is thereby reduced which makes cooling less problematic (Q=quantity of heat to be removed from fuel cell unit 1, i.e., the fuel cell system, dT=the driving temperature gradient between a cooling medium and fuel cell unit 1, especially in an automobile radiator, which corresponds to the difference between the exit temperature of the cooling medium from fuel cell unit 1, or fuel cell system, and the ambient temperature). Specifically, when the fuel cell system is used in a vehicle, the temperature of the ambient air and the radiator surface, which is greatly restricted by the drag coefficient requirements dictated by the body design, are normally available for cooling; at low pressure, corresponding to a partial load, it is very difficult to remove the heat that arises under a full load when the ambient temperature is high, for example during summer, and this can limit the performance of the fuel cell system.

It is particularly advantageous for oxidant supply unit 5 to be at least partially driven by a gas turbine 7 in the fuel cell system. In so-called “boost operation,” additional output power can be made accessible to the consumers 4, and cooling becomes less problematic.

The gas turbine is preferably heated by a combustion chamber 8 in the fuel cell system. Combustion chamber 8 can be operated by separately carried fuel and/or fuel cell exhaust.

It is particularly preferable for gas turbine 7 to drive oxidant supply unit 5 only when the fuel cell system load demand is high. By restricting the gas turbine 7 boosting time, propulsive power can be made available that is far beyond the maximum rating for electric motor 6 of oxidant supply unit 5, which can significantly increase the pressure and hence the operating temperature of fuel cell unit 1. This produces a higher current density in fuel cell unit 1 and hence a higher fuel cell unit 1 output under a full load without changing the size of fuel cell unit 1.

It is particularly advantageous that electrical power can be provided to electrical consumers 4 from drive motor 6 of oxidant supply unit 5 when oxidant supply unit 5 is driven by gas turbine It is particularly preferable to supply the power to an electrical propulsive drive.

Overall, the present invention allows the efficiency of the fuel cell system to be increased in the partial load range, which allows consumption to be reduced. By increasing the pressure in the partial load range, the operating temperature can be raised, which makes cooling less problematic. In addition, power reserves can be temporarily mobilized by boosting.

What is claimed is:

1. A method for operating a fuel cell system with variable pressure, the fuel cell system having a fuel cell unit with a plurality of fuel cells, the method comprising:
supplying a cathode of one of the fuel cells with an oxidant that chemically reacts with a fuel supplied to an anode of the one fuel cell;
providing an electrical output generated by the reaction in the fuel cell unit to at least one electrical consumer, the electrical output at a load level of the fuel cell unit being variable as a function of a pressure, the pressure being applied from at least one oxidant supply unit conveying the oxidant to the cathode;
adjusting or adapting, for the load level demanded by the fuel cell system, a pressure dependence of the electrical output of the fuel cell unit with respect to an electrical power required for operating the oxidant supply unit; and
setting the pressure for the oxidant to a level corresponding to a minimum required electrical power for the oxidant supply unit.

2. The method as recited in claim 1 wherein the pressure dependence of the electrical output of the fuel cell unit is adjusted to the electrical power required for operating the oxidant supply unit at each load level.

3. The method as recited in claim 1 wherein the pressure is changed continually over a load range of the fuel cell unit.

4. The method as recited in claim 1 wherein additional electrical components of the fuel cell system are included in the adjustment to determine the minimum required electrical power for the oxidant supply unit at the load level.

5. The method as recited in claim 1 wherein at an elevated pressure compared to that in a partial load range, a higher operating temperature for the fuel cell unit is permitted.

6. The method as recited in claim 1 further comprising at least temporarily driving the oxidant supply unit by a gas turbine in the fuel cell system.

7. The method as recited in claim 6 wherein the gas turbine is heated by a combustion chamber in the fuel cell system.

8. The method as recited in claim 7 wherein the gas turbine at least partially drives the oxidant supply unit when loads exceeding a certain amount are demanded from the fuel cell system.

9. The method as recited in claim 6 wherein an output from an electric drive motor of the oxidant supply unit is supplied to the consumer when the oxidant supply unit is driven by the gas turbine.

10. The method as recited in claim 9 wherein the consumer is an electrical propulsive drive.

11. The method as recited in claim 1 wherein oxidant supply unit is a compressor/expander designed to operate at every load level, taking into account the adjustment of the pressure dependence of the electrical output of the fuel cell unit to the electrical power required for operating the oxidant supply unit.
